(19) United States
(12) Patent Application Publication
(10) Pub. No.: US 2008/0232102 A1
(43) Pub. Date: Sep. 25, 2008

(54) Emergency light fixture having an efficient reflector assembly

(75) Inventors: Patrick Martineau, Ile-Perrot (CA); Radu Cornel Rapeanu, Mont-Royal (CA)

Correspondence Address: HOFFMANN & BARON, LLP, 6900 JERICHO TURNPIKE, SYOSSET, NY, 11791, US

(73) Assignee: Thomas & Betts International, Inc., Wilmington, DE (US)

(21) Appl. No.: 11/935,450

(22) Filed: Nov. 6, 2007

Related U.S. Application Data
(60) Provisional application No. 60/896,015, filed on Mar. 21, 2007.

(51) Int. Cl. F21V 7/06; B29D 11/00

(52) U.S. Cl. 362/235; 264/1.1; 362/346

(57) ABSTRACT

An emergency light fixture includes at least two light sources and a reflector. The light sources are disposed within the reflector. The reflector includes a first concave surface formed by rotating a first parabola about a first central axis of the first parabola, a second concave surface formed by rotating a second parabola about a second central axis of the second parabola, and a third concave surface formed by translating a third parabola along a substantially straight line. The third concave surface intersects the first concave surface and the second concave surface. The light sources may be disposed at the foci of the first and second parabolas or offset from the foci. The first and second central axes may be oriented at symmetrical angles with respect to a plane bisecting the third parabola. The reflector preferably has no convex joints. The first, second, and third parabolas may be degenerated. A third light source may be disposed within the third concave surface.

### CROSS-REFERENCE TO RELATED APPLICATION

This application claims the benefit of U.S. Provisional Patent Application No. 60/896,015 filed Mar. 21, 2007, the disclosure of which is incorporated herein by reference.

### BACKGROUND OF THE INVENTION

1. Field of the Invention

The present invention generally relates to emergency lighting fixtures. In particular, the present invention provides for an improved reflector for use in emergency lighting fixtures.

2. Description of the Related Art

Typically, emergency lighting fixtures 10 include two lamps, each of which can be adjusted to a desired direction, as shown in FIG. 11. The end users then adjust the lamps 10 as best they can to obtain uniform illumination on the floor. However, the resulting illumination is often inconsistent and the light pattern 12 of these units is incompatible with typical paths of egress 14.

Alternative solutions, which include emergency lights with a reflector specifically dedicated for corridors or hallways, have been developed. Some emergency lighting fixtures, found in the prior art, use an adjustable system with two (2) lamps and two (2) optical cavities, as described in U.S. Pat. No. 7,147,348 to Heaton et al., which is incorporated herein by reference. Other fixtures develop systems that combine very efficient lenses (refraction) with inefficient reflectors, while the use of refraction in the lens results in the loss of light. Some fixtures, in an effort to meet the requirements of the specification, include an inefficient reflector/refractor with more lamps which results in a larger unit with lower efficiency.

In the automotive industry, for example, headlight designers must develop two (2)-lamp reflectors that generate the same type of light patterns. Such lamps are in independent cavities, as described in U.S. Pat. No. 5,117,336 to Scenzi; U.S. Pat. No. 5,140,504 to Cheney et al.; and U.S. Pat. No. 4,895,814 to Kanzaki et al., which are incorporated herein by reference, resulting in larger reflectors. Some of these fixtures have control in only one direction, usually in the vertical, but rarely in both the vertical and horizontal directions.

### SUMMARY OF THE INVENTION

An emergency light fixture formed in accordance with an embodiment of the present invention, incorporates some preferred features, including at least two light sources, and a reflector. The light sources are at least partially disposed within the reflector. The reflector includes a first concave surface formed by rotating a first parabola about a first central axis of the first parabola, a second concave surface formed by rotating a second parabola about a second central axis of the second parabola, and a third concave surface formed by translating a third parabola along a substantially straight line. The third concave surface intersects the first concave surface and the second concave surface.

The light sources may be disposed at the foci of the first and second parabolas or offset therefrom. The first and second central axes may be oriented at symmetrical angles with respect to a plane bisecting the third parabola. The reflector preferably has no convex joints. At least one of the first, second, and third parabolas may be degenerated, and a third light source may be disposed at least partially within the third concave surface.

These and other objects, features, and advantages of this invention will become apparent from the following detailed description of illustrative embodiments thereof, which is to be read in connection with the accompanying drawings.

### BRIEF DESCRIPTION OF THE DRAWINGS

FIG. 1 shows an emergency light fixture in accordance with the present invention installed on a wall and a path of egress to be illuminated.

FIGS. 2a and 2b show a length of a light pattern of the emergency light fixture controlled by tilting a focal axis of its reflector.

FIGS. 3a and 3b show a light pattern position C of the emergency light fixture controlled by tilting its reflector.

FIG. 4a shows a front view of the reflector of the emergency light fixture.

FIG. 4b shows a side view of the reflector.

FIG. 5 shows a preferred filament alignment in the reflector.

FIGS. 6a-6d show various profiles than can be used to control light distribution.

FIGS. 7a and 7b show how the distribution in a direction A works with the contribution of various rays.

FIGS. 8a and 8b show the length of the path, the same distribution shown in FIGS. 7a and 7b.

FIG. 9 shows an isometric view of a path of egress, the contribution of reflected rays (A′×B′), and the combination of both direct and reflected rays (A×B).

FIG. 10 shows an asymmetrical illuminated path.

FIG. 11 shows how typical emergency lighting units work.

FIGS. 12 to 15 show how the present invention has been integrated in the emergency light fixture, in accordance with the present invention.

FIG. 16 shows another embodiment of the emergency light fixture with three (3) light sources.

FIG. 17 shows a light pattern generated by the three-light source reflector shown in FIG. 16.

FIGS. 18a-d show various views of a reflector for use in the emergency light fixture of the present invention, in which surfaces S1 and S2 are not generated by rotation of a parabola around an optical axis.

FIGS. 19a-e show various views of a preferred reflector for use in the emergency light fixture of the present invention, in which surfaces S1 and S2 are generated by rotation of a parabola around an optical axis.

### DETAILED DESCRIPTION OF THE PREFERRED EMBODIMENTS

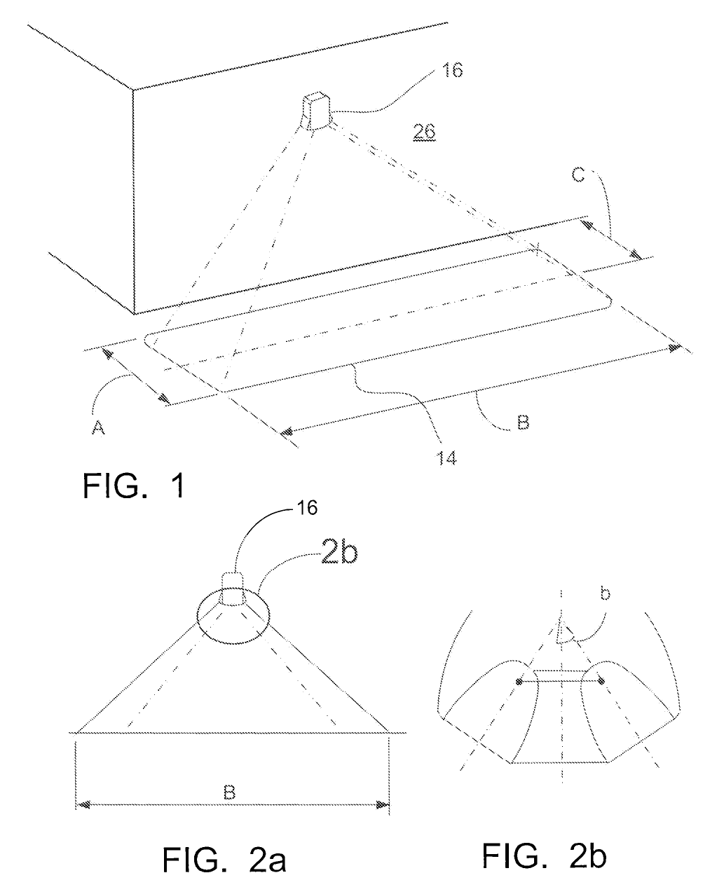

The present invention is directed to an emergency light fixture 16, as shown in FIG. 1, which includes a compact and efficient reflector. The purpose of the emergency light fixture 16 is to illuminate a path of egress 14 during emergency evacuation. Usually, paths of egress are long and narrow, and have a width of three (3) to six (6) feet, and a length as long as seventy (70) feet, such as that of a corridor or hallway, shown in FIG. 1. The design of the reflector, in accordance with the present invention, is adapted to a corridor/hallway-type of path.

There is a demand in the marketplace to improve the integration of emergency light fixtures with existing architectural structures, such that their visual impact is reduced. The emergency light fixture 16, in accordance with the present invention, addresses this growing need in two ways. First, the emergency light fixture 16 significantly improves optical efficiency, which translates into fewer units that need to be installed. Second, the overall size of an installed unit is significantly reduced by the use of a compact reflector.

The emergency light fixture 16, in accordance with the present invention, includes two light sources contained in emergency lighting that are incorporated in the same optical cavity. This configuration does not compromise the control of a light pattern, and substantially reduces the reflector size. The two light sources address the redundancy requirement specific to emergency lighting. The light control is excellent in both directions, i.e. the length and the width, of the path to be illuminated. The emergency light fixture 16 of the present invention is adapted to illuminate narrow paths of egress, such as the corridor shown in FIG. 1.

A reflector 24 preferably includes three concave surfaces S1, S2, and S3, shown in FIG. 4a, which are generated by parabolic curves. Two of the surfaces, S1 and S2, preferably have the shape of a parabolic cone, which is developed by rotation of a parabola about its central axis 22. The cones preferably have their axes oriented at symmetrical angles b, shown in FIG. 4a. The third surface S3 is preferably a parabolic cylinder, which is developed by the translation of a parabola and the intersection of each of the cones described above, as shown in FIG. 4b.

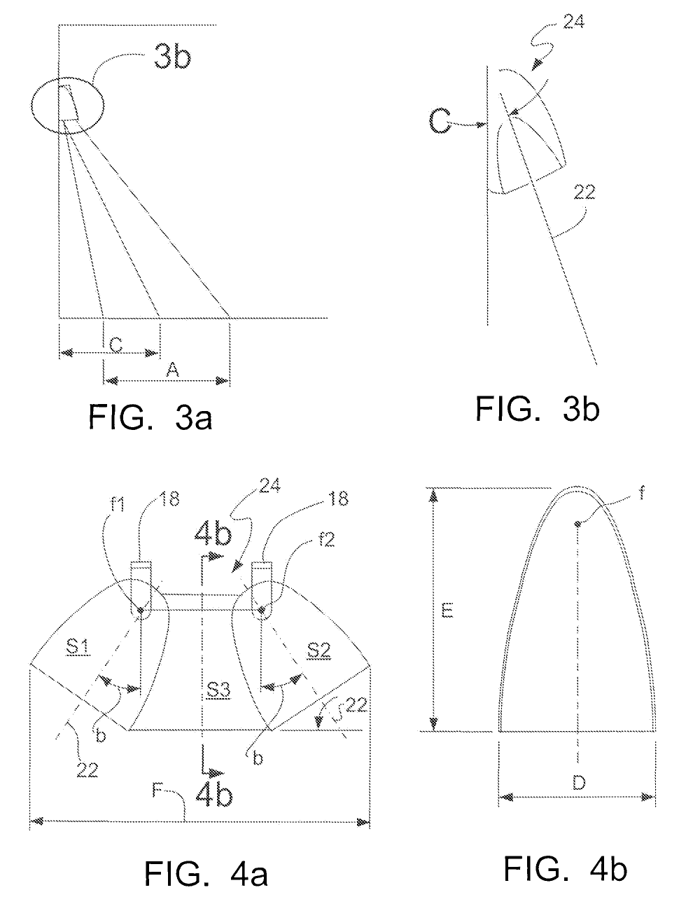

The two lamps 18 are preferably positioned in the focus f₁ and f₂ of each cone. The lamps 18 preferably have their filaments aligned with a long horizontal axis 20 of the reflector, as shown in FIG. 5. The two cone axes 22 are preferably co-planar and have their plane tilted at a certain angle c, shown in FIG. 3b. This angle preferably controls the distance of the illuminated path from the wall on which the emergency fixture 16 is installed.

The resulting reflector surface preferably has only a concave shape with no convex joints, allowing the light emitted by each lamp 18 to reach any point of the reflector surface.

The orientation angle of the cone axes 22 preferably controls the length of the illuminated path of egress. The tilt angle of the axes plane b, shown in FIG. 2b, preferably controls the length of the illuminated path.

FIG. 1 shows the fixture 16 installed on a wall 26, with the mounting height preferably about eight (8) feet, and the path of egress to be illuminated. Width A is narrower than length B, and thus the ratio B/A can be as high as forty (40). With the reflector design of the present invention, both width A, length B, and position C can be controlled. Typically, controlling the light with refraction results in light loss. The emergency light fixture 16, in accordance with the present invention, is controlled with only a reflector, and thus is more efficient and can prevent light loss.

FIGS. 2a and 2b show the length of the light pattern preferably controlled by tilting the focal axis by b degrees.

FIGS. 3a and 3b show the light pattern position C preferably controlled by tilting the reflector by c degrees.

FIG. 4a shows a front view of the reflector. Surfaces S1 and S2 are preferably generated by revolving a profile around the axis 22, as shown, to generate a cross-sectional profile. Surface S3 is obtained by extruding the same profile in an approximately linear path between surfaces S1 and S2. Further, the focal points f₁ and f₂ of the two light sources are also shown.

FIG. 4b shows the overall size of the reflector, which typically presents a major design constraint.

FIG. 5 shows an incandescent bulb, or lamp, 18, which is the preferred light source for the reflector 24. Light Emitting Diodes (LEDs) or other compact light sources, however, can also be used while remaining within the scope of the present invention. FIG. 5 shows the lamps 18 with the preferred filament alignment. In the position illustrated, the image of the filament will have the same shape as the path of egress. FIG. 5 shows how compact the reflector 24 can be made.

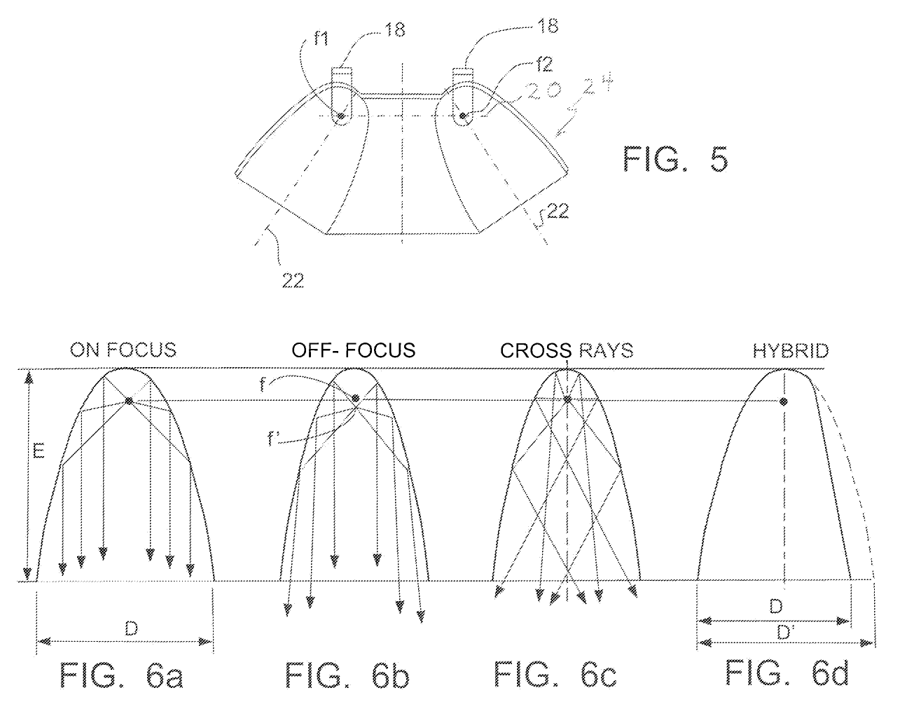

FIGS. 6a-d show various profiles that can be used to control the light distribution in width direction A of FIG. 1. Each of the profiles preferably has the same dimensional limitations D and E. FIG. 6a shows a perfect collimator, which will generate a narrow beam, typically too narrow for emergency lighting. FIG. 6b shows a light off-focus, which results in a fairly narrow and intense section surrounded by a wider, dimmed section. FIG. 6c shows a design approach in which the profile is optimized to obtain a uniform distribution. In this approach, the rays cross the optical axis, resulting in a more efficient profile for given dimensional constraints D and E. This is the preferred embodiment with which a precise control can be obtained. FIG. 6d shows a hybrid design, which has a symmetrical profile such as that shown in FIGS. 6a, 6b, and 6c, and has been cut by a plane in order to fit within dimension D. The drawback of such design is that the flat surface, or plane, is less efficient.

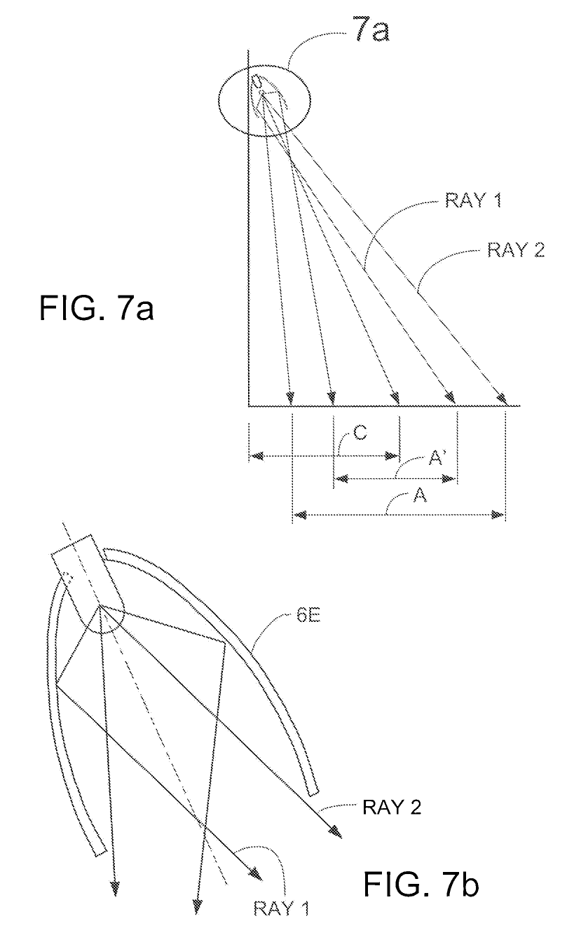

FIG. 7a shows a similar concept as FIG. 3, but further illustrates, in detail, how the distribution in direction A works with the contribution of various rays. FIG. 7b shows a close-up of this concept. Preferably, all rays that hit the reflector surface, such as Ray 1, are redirected within area A′, yet the rays that are not reflected, such as Ray 2, are not lost, but preferably remain within area A. The result is an efficient reflector, in which all the rays are redirected within the path of egress.

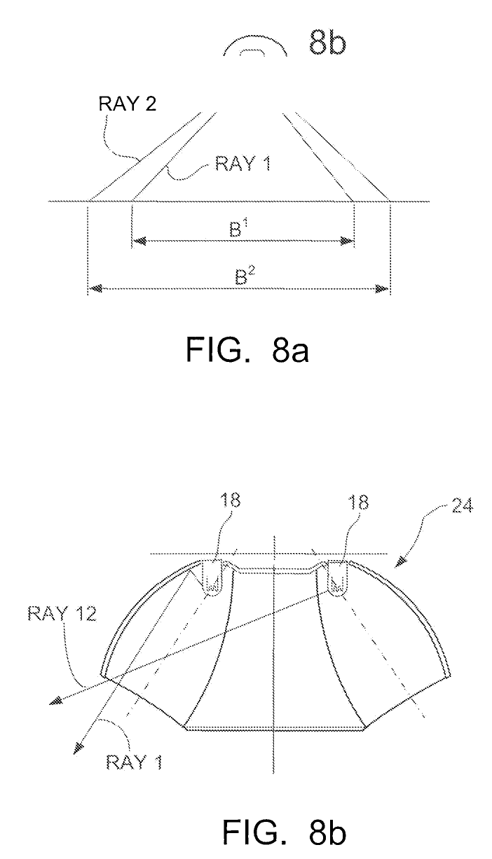

FIGS. 8a and 8b show the length of the path, the same distribution is shown in FIGS. 7a and 7b.

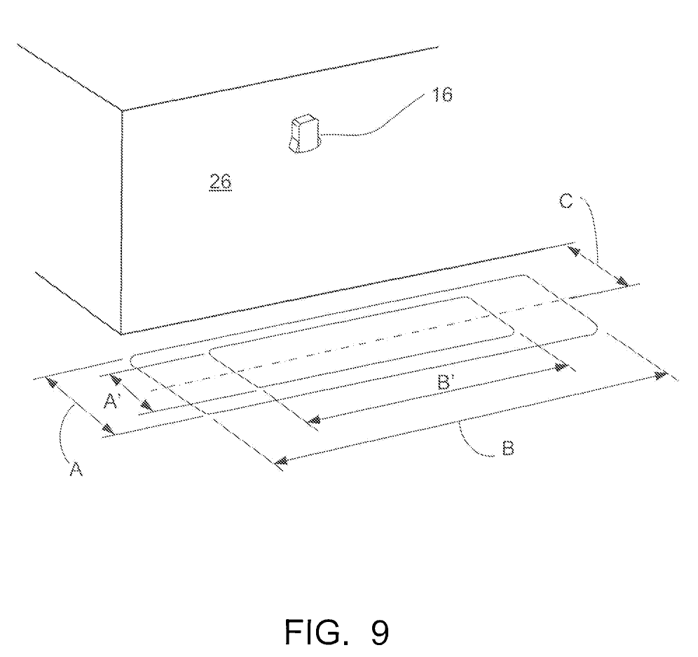

FIG. 9 shows an isometric view of the path of egress, the contribution of the reflected rays (A′×B′), and the combination of both direct and reflected rays (A×B).

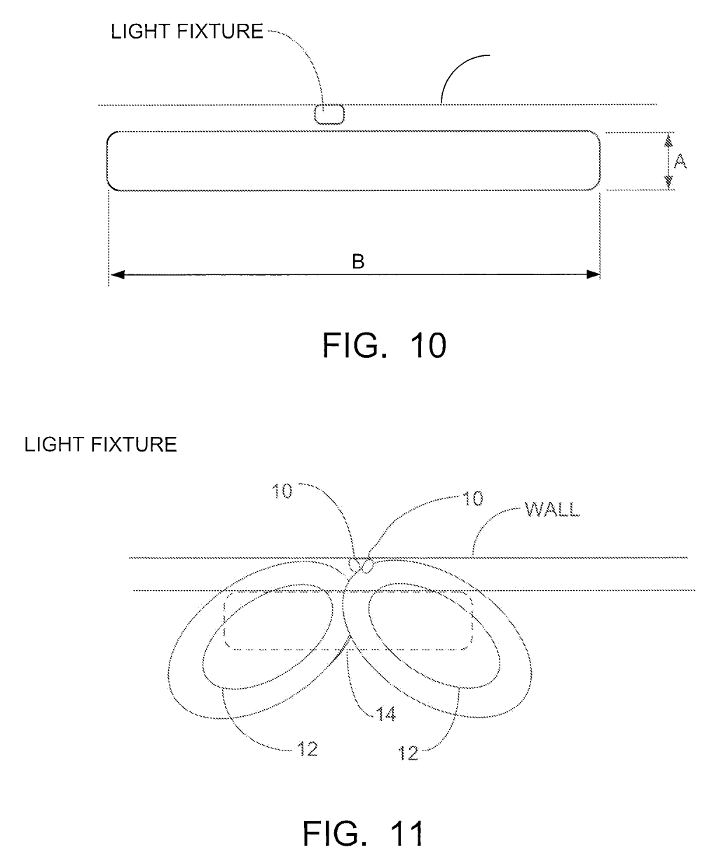

FIG. 10 shows how asymmetrical the illuminating path can be, by illustrating that the length B of the path can be three (3) to forty (40) times the width A of the path.

FIG. 11 shows how typical emergency lighting units work. Two lamps with symmetrical beams are oriented to provide an asymmetrical composite beam, much like trying to fit a circular shape in a rectangular area. The present invention preferably fits a rectangular shape in a rectangular area.

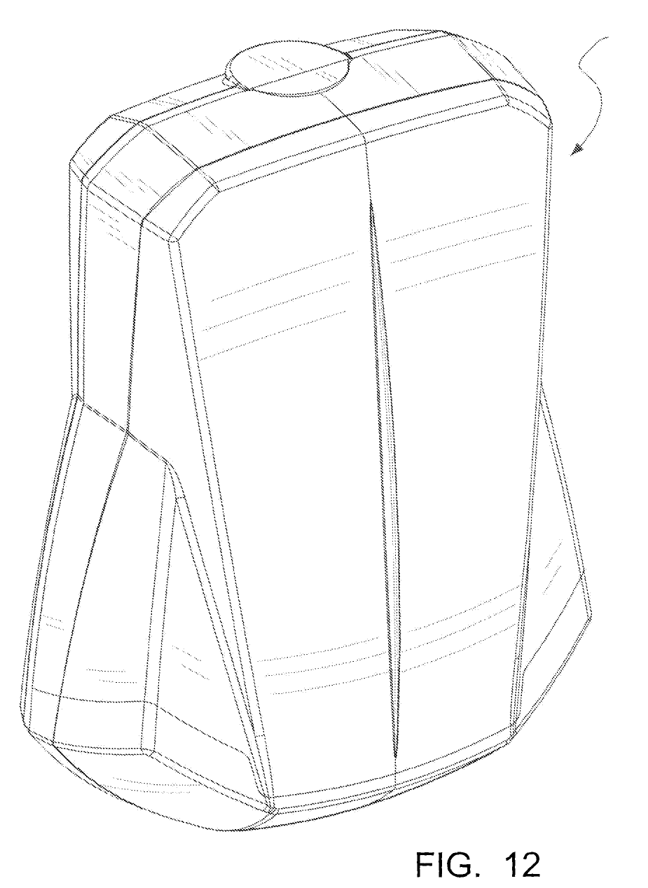

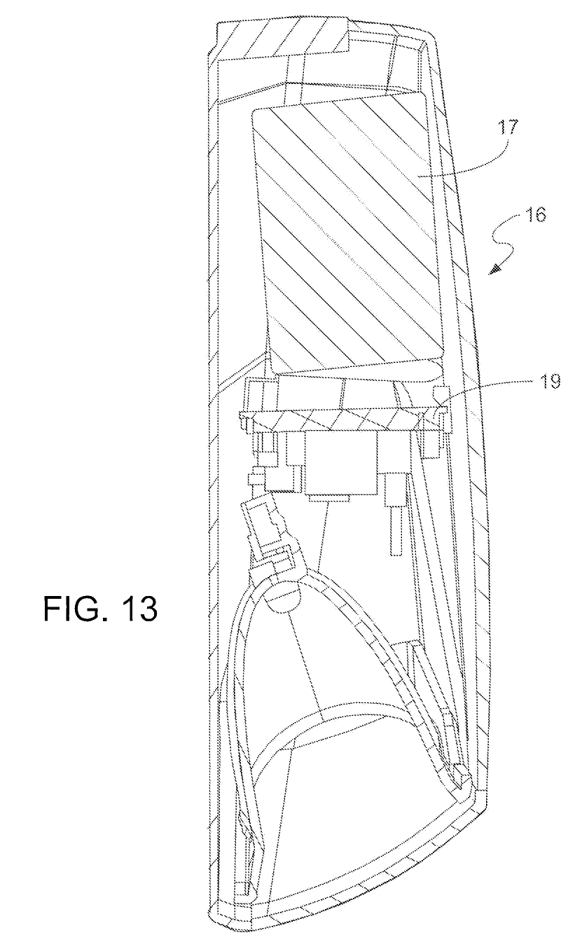

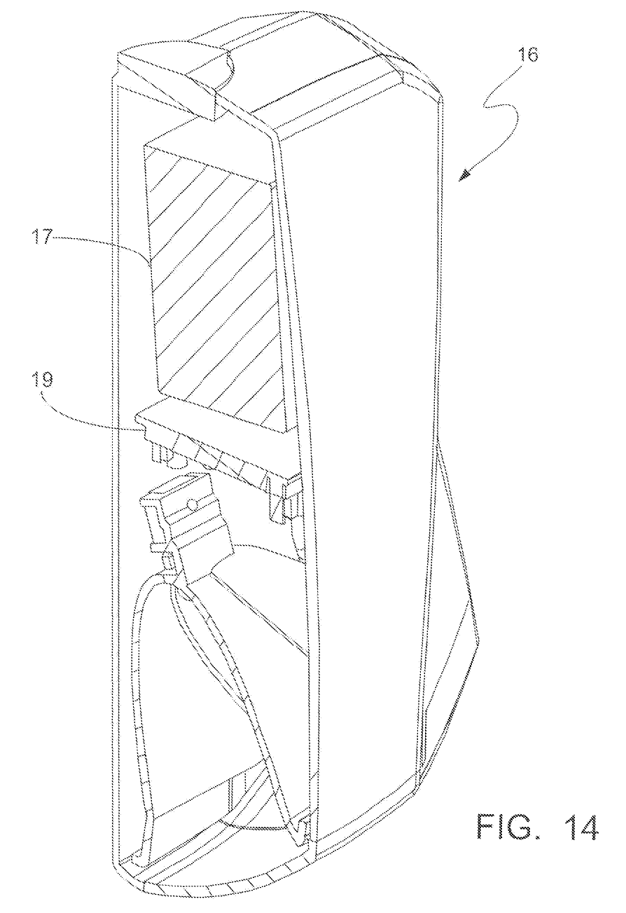

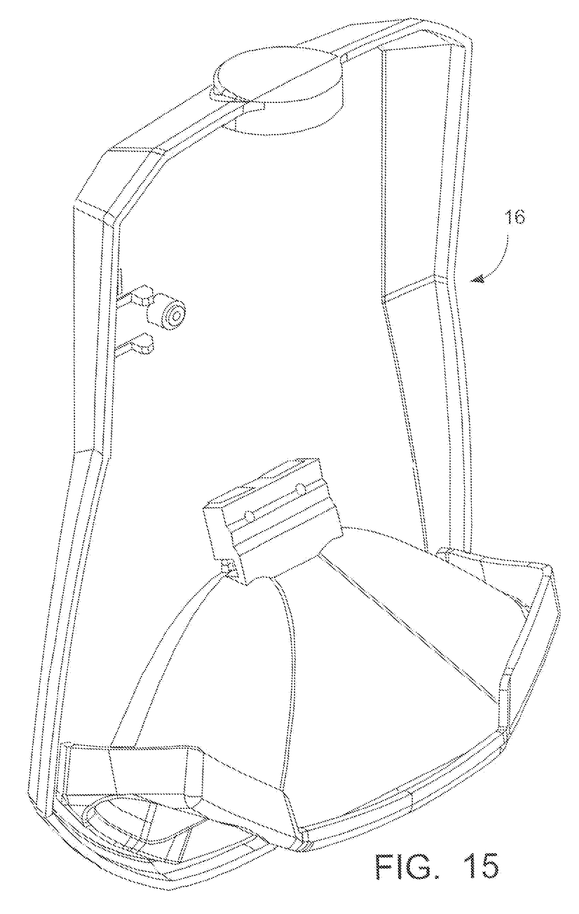

FIGS. 12 to 15 show how the present invention has been integrated in the emergency light fixture 16 in accordance with the present invention.

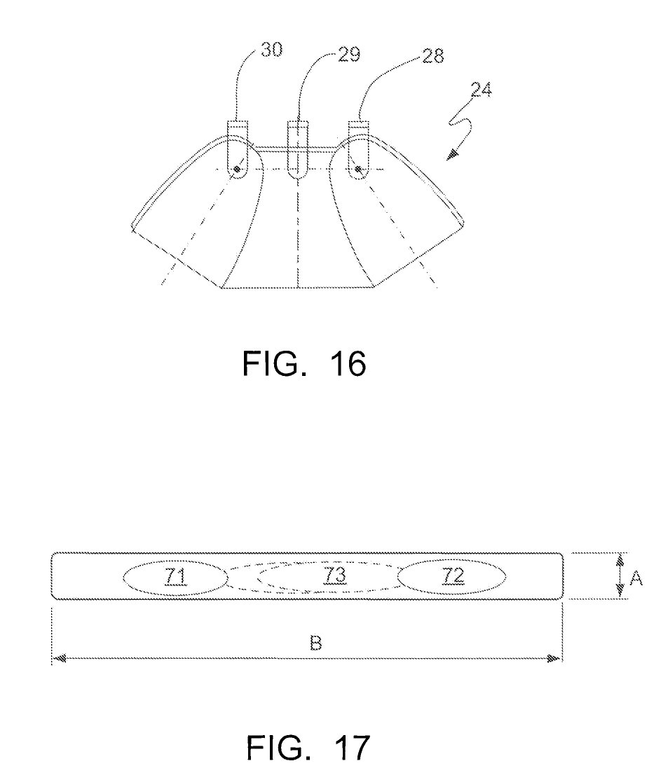

FIG. 16 shows another embodiment with three (3) light sources, 28, 29, and 30. When the target spacing between units is more than thirty (30) feet, for an eight (8)-foot mounting height, it becomes difficult to generate a uniform light pattern. Thus, a third lamp 29 can be added in the center to overcome the spacing problem.

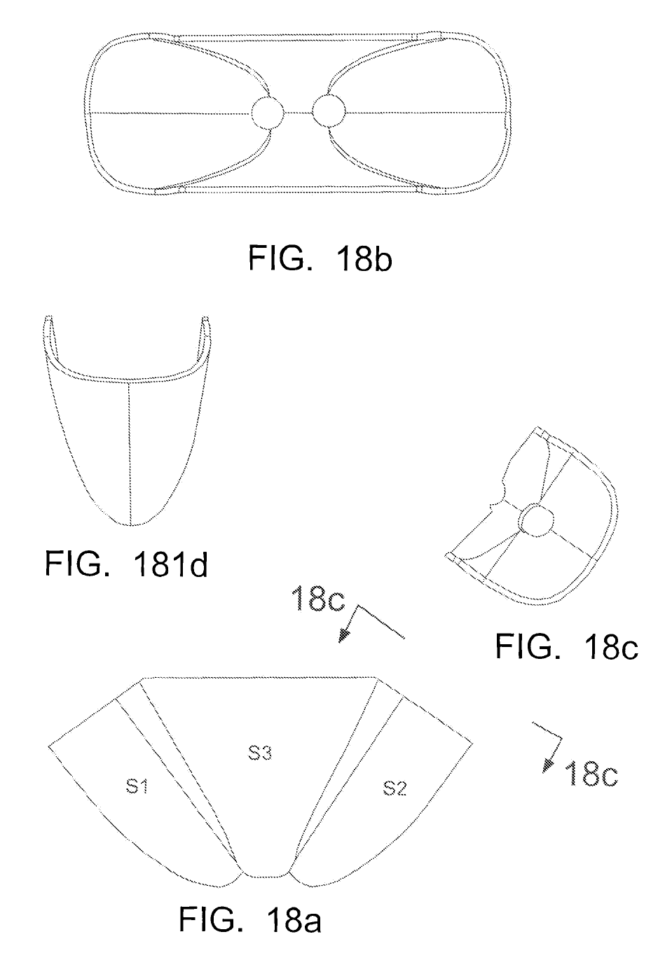

FIG. 17 shows the light pattern generated by a three-light source reflector 24, presented in FIG. 16. The third lamp 29 preferably fills the dimmer zone Z3, between zones Z1 and Z2. Zones Z1 and Z2 represent the brighter spots generated by lamps 28 and 30.

FIGS. 18a-d show various views of an embodiment of the reflector for use in the emergency light fixture, in accordance with the present invention, in which surfaces S1 and S2 are not developed by rotation around an optical axis.

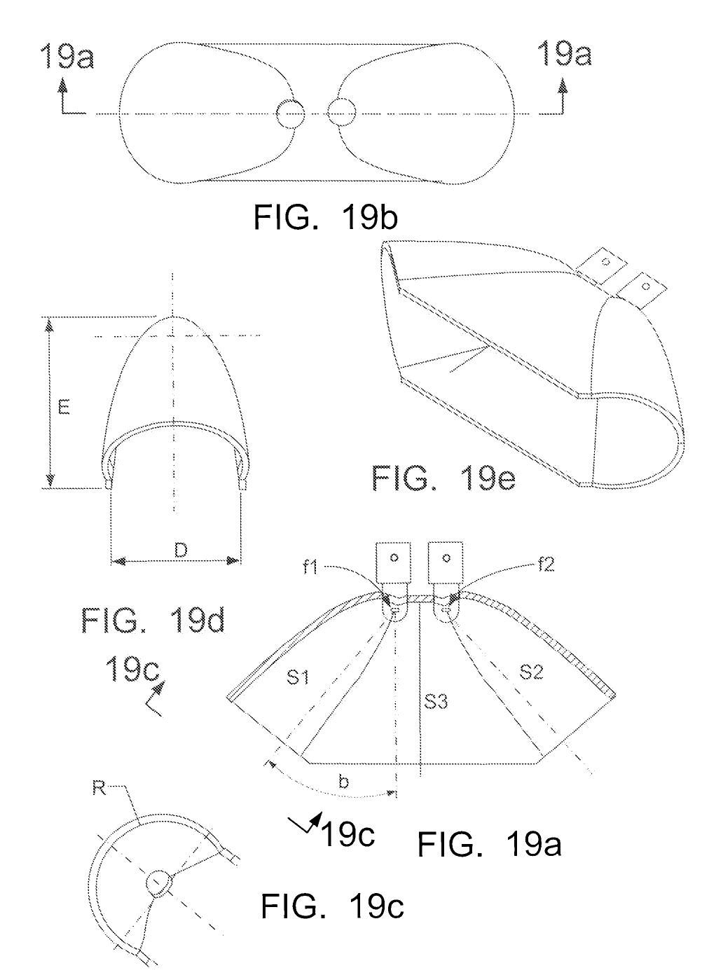

FIGS. 19a-e show the preferred embodiment of the reflector for use in the emergency light fixture, in which surfaces S1 and S2 are developed by rotation around an optical axis.

The following modifications are intended to be within the scope of the present invention:

1. A light reflector as described above, with the surfaces based on degenerated parabolas. One can control the width of the illuminated path by uniformly degenerating the parabola curves, with larger or smaller openings.

2. A light reflector as described above, with the position of lamps offset a certain distance from the focus of the parabolas, as shown in FIG. 6b.

3. A light reflector as described above, with a non-parabolic profile, as shown in FIGS. 6c and 6d.

4. A light reflector as described above, including three lamps: two as described above and the third lamp in the center of the reflector, with the filament aligned with the other two lamp filaments, as shown in FIG. 16.

5. A light reflector as described above, with surfaces S1 and S2 not developed by a rotation, as shown in FIG. 18.

6. A light reflector as described above, with a profile of a single-segment curve defined by a polynomial, quadratic, or conical function; or a multiple-segment curve defined by line, polynomial, quadratic, or conical function.

The advantages of the present invention include an increased utilization of the reflector surface, a uniform distribution pattern, such that the fixture does not need a diffusing lens, a lower level of light absorption, and consequently an improved light efficacy due to the preferred use of a clear lens in the fixture. The present invention is efficient, compact, and has optimal control of the light in all directions.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. An emergency light fixture comprising:
at least two light sources; and
a reflector, the at least two light sources being at least partially disposed within the reflector, the reflector comprising a first concave surface formed by rotating a first curve about a first central axis of the first curve, the reflector comprising a second concave surface formed by rotating a second curve about a second central axis of the second curve, the reflector comprising a third concave surface formed by translating a third curve along a substantially straight line, the third concave surface intersecting the first concave surface and the second concave surface, the reflector forming a single cavity.

2. The emergency light fixture as defined by claim 1, wherein the at least two light sources are disposed at the foci of the first and second curves.

3. The emergency light fixture as defined by claim 1, wherein the first and second central axes are oriented at symmetrical angles with respect to a plane bisecting the third curve.

4. The emergency light fixture as defined by claim 1, wherein the at least two light sources are offset from the foci of the first and second curves.

5. The emergency light fixture as defined by claim 1, further comprising a third light source dispose at least partially disposed within the third concave surface.

6. The emergency light fixture as defined by claim 1, wherein the first and second concave surfaces are not developed by rotation.

7. The emergency light fixture as defined by claim 1, wherein at least one of the curves comprises at least one of a single-segment curve and a multiple-segment curve.

8. The emergency light fixture as defined by claim 1, wherein the at least one of the curves is defined by at least one of a polynomial, quadratic, conical, and line function.

9. The emergency light fixture as defined by claim 1, wherein at least one of the curves comprises a parabola.

10. A reflector adapted to be used in an emergency light fixture comprising:
a first concave surface formed by rotating a first curve about a first central axis of the first curve;
a second concave surface formed by rotating a second curve about a second central axis of the second curve;
a third concave surface formed by translating a third curve along a substantially straight line, the third concave surface intersecting the first concave surface and the second concave surface.

11. The reflector as defined by claim 10, wherein the first and second central axes are oriented at symmetrical angles with respect to a plane bisecting the third curve.

12. The reflector as defined by claim 10, wherein the first and second concave surfaces are not developed by rotation.

13. The reflector as defined by claim 10, wherein at least one of the curves comprises at least one of a single-segment curve and a multiple-segment curve.

14. The reflector as defined by claim 10, wherein the at least one of the curves is defined by at least one of a polynomial, quadratic, conical, and line function.

15. The reflector as defined by claim 10, wherein at least one of the curves comprises a parabola.

16. The reflector as defined by claim 10 further comprising a single cavity.

17. A method of manufacturing a reflector adapted to be used in an emergency light fixture comprising:
providing a first concave surface formed by rotating a first curve about a first central axis of the first curve;
providing a second concave surface formed by rotating a second curve about a second central axis of the second curve;
providing a third concave surface formed by translating a third curve along a substantially straight line, the third concave surface intersecting the first concave surface and the second concave surface.

18. The reflector as defined by claim 17, wherein the first and second central axes are oriented at symmetrical angles with respect to a plane bisecting the third curve.

19. The reflector as defined by claim 17, wherein the first and second concave surfaces are not developed by rotation.

20. The reflector as defined by claim 17, wherein at least one of the curves comprises at least one of a single-segment curve and a multiple-segment curve.

21. The reflector as defined by claim 17, wherein the at least one of the curves is defined by at least one of a polynomial, quadratic, conical, and line function.

22. The reflector as defined by claim 17, wherein at least one of the curves comprises a parabola.

23. The reflector as defined by claim 17 further comprising a single cavity.
